(19) United States
(12) Patent Application Publication
(10) Pub. No.: US 2004/0086611 A1
(43) Pub. Date: May 6, 2004

(54) Method of treating barley

(76) Inventor: Owe Forsberg, Stavanger (NO)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/469,614

(22) PCT Filed: Mar. 5, 2002
(86) PCT No.: PCT/NO02/00090

(30) Foreign Application Priority Data
Mar. 6, 2001 (NO) 20011136

(51) Int. Cl. A23L 1/10

(52) U.S. Cl. 426/464

(57) ABSTRACT

A method of treating barley, in which the barley is kept heated between half an hour and two hours, whereupon it is pulverized into a powder, preferably after being cooled.

This invention regards a method of treating the grain species of barley in a manner such that the content of nutrients, fibres and other constituents of the barley may be utilised better by humans and animals than that which is common when using prior art.

It is well known that barley contains many constituents that are good for the body, and it has through decenniums been used as food for humans and animals. Nevertheless, most of the available barley is sold as an ingredient for fodder concentrates. Thus barley has a negligible direct use as food for humans, due among other things to relatively unsuitable methods of treatment.

Appropriate and cost effective methods of treating barley in a manner such that the constituents of the barley are taken care of in their entirety and at the same time made available for the human digestion, are not known.

The constituents of the barley deteriorate significantly when using conventional cooking and baking methods, and have also to some extent proven to be unsuitable for converting some of the nutrients into a form that may be utilised by the digestive system.

The object of the invention is to remedy the disadvantages of prior art.

The object is achieved in accordance with the invention by the characteristics stated in the description below and in the appended claims.

Through briefly heating the barley in e.g. wet steam at a controlled degree of humidity, and subsequent pulverization, it has proven possible to take care of essentially all the constituents of the barley while at the same time, a significantly greater fraction of the constituents have assumed a form that may be utilised by the digestive system of a human or animal body, than that which is the case with prior art.

A preferred version of the method typically comprises a series of operations described below.

After winnowing, the barley is first ground in order to remove the husks, whereupon the grain is screened. Doing this removes undesirable contaminants such as e.g. fungus, in addition to the husks. The ground, clean grains of barley are then steamed, depending on among other things the size and type of grain, in saturated steam between half an hour and two hours. The humidity of the steam is controlled so that the grains of barley are wetted by the steam during the cooking process without any significant formation of drops of water. Precipitation of excess water on the grains causes some of the essential constituents of the grain to be washed away from the barley. The barley is milled while it is hot and moist, immediately after boiling.

The subsequent pulverization, which preferably takes place in a stone mill, has proven to yield the best results at a grain moisture content of about 15%. If the grain contains more moisture after milling, it must be dried while being cooled to ambient temperature.

Pulverization of the boiled grain in a stone mill will, particularly if being milled prior to this, give a powder rich in long fibres. Such relatively long fibres bind to the waste products in an intestine, thus contributing to the excretion of these.

The pulverized powder may be consumed in its natural form, or possibly seasoned with flavour additives and/or be mixed with water.

The following describes a non-limiting example of a preferred embodiment illustrated in the accompanying flow diagram, in which:

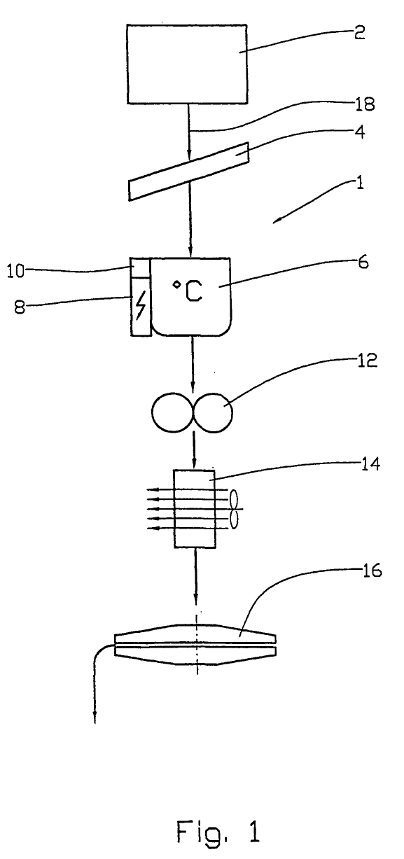

FIG. 1 shows the sequence and the various steps in the treatment.

In the flow diagram, reference number 1 denotes a production line for producing a barley powder according to the invention, typically comprising a grinding/abrading machine for grain 2, a winnowing screen 4, a steam boiler 6 with associated steam generator 8 and control equipment 10, a grain milling machine 12, a drier 14 and a flour mill 16, all of a design that is know per se. Arrows 18 indicate the direction of conveyance of the grain through the production line 1. The required subsequent packaging equipment is not shown.

When the barley is to be treated, it is introduced to the grinding machine 2 in which the husk is removed from each grain. Residual husks and other superfluous and undesirable materials are removed in a winnowing screen 4, while the winnowed grain is carried to a steam boiler 6. The grain remains in the steam boiler 6 until the carbohydrates in the kernels of the grain are sufficiently fused together to enable them to be utilised by the digestive system of the human body. The steam generator 8 of the steam boiler 6 is controlled by the controller 10, so that the grains of barley remain moist during boiling, but without any significant formation of major water drops on the barley.

After the barley has finished boiling, it is passed though a grain milling machine 12 and into a drier 14, for instance of the type in which air is blown through the grain, and where it is cooled and dried as required.

A degree of humidity of the order of 15% has proven to help produce a long fibre powder during the pulverization process in the flour mill 16.

Following pulverization, the powder is packaged by means of well known equipment (not shown) for this purpose.

Barley powder treated according to the invention has proven to be well suited for use as a dietary supplement for regulating the digestive process in humans and animals, and for providing the body with a quick infusion of energy. Experiments have been conducted that appear to indicate that some of the constituents of the barley, after being treated in this manner, are transported directly into the blood without being digested in the normal manner.

1. A method of treating barley where the barley is kept heated at a temperature of between 65 and 105 degrees Celsius between 15 minutes and two hours, characterized in that the barley is milled while hot and preferably moist whereupon it is pulverized, preferably after being cooled.

2. A method in accordance claim 1, characterized in that the barley is ground and screened prior to being heated.

3. A method in accordance with one or more of the preceding claims, characterized in that the barley, containing 10 to 20 percent of water, is pulverised in a stone mill.
